(19) United States
(12) Patent Application Publication
(10) Pub. No.: US 2016/0060916 A1
(43) Pub. Date: Mar. 3, 2016

(54) Flush Door Latch

(71) Applicant: QRP, Inc., Leland, NC (US)

(72) Inventor: Andres Hernandez, Yorba Linda, CA (US)

(21) Appl. No.: 14/836,949

(22) Filed: Aug. 26, 2015

Related U.S. Application Data
(60) Provisional application No. 62/041,899, filed on Aug. 26, 2014.

(51) Int. Cl. E05C 3/12; E05C 3/16

(52) U.S. Cl. CPC E05C 3/122; E05C 3/167

(57) ABSTRACT

A “pop-out” latch includes trigger-actuated spring means for extending a latch handle out of a surrounding panel recess for ease of grasping. The handle is connected to an inner sleeve which is keyed to a concentric outer sleeve such that the sleeves turn together between open and closed positions while the inner sleeve can slide axially within the outer sleeve between extended and retracted positions. At least one control pin extends inwardly from the latch body through slots in both sleeves. By the location of the slots the rotation of the handle is only permitted when the inner sleeve is in the extended position. When closing the latch, movement of the handle and inner sleeve axially toward the retracted stowed position of the handle is only permitted when the handle is in alignment with the receiving panel recess.

### RELATED APPLICATIONS

This patent application is a non-provisional patent application of provisional patent application No. 62/041,899 entitled “Flush Door Latch” filed Aug. 26, 2014, priority from which is hereby claimed.

### FIELD OF THE INVENTION

The present invention relates to hand-turned door latches used to hold moveable doors and panels in place, usually in their closed condition. More specifically, the invention relates to “pop-out” latches of the type where the handle retracts flush with the surrounding outer surface of the door or panel when the door is closed.

### BACKGROUND OF THE INVENTION

Latches with flush or near-flush handles have been devised in different ways so that the handle can be actuated to pop out for manual access. Many of these devices incorporate a reciprocal spring mechanism to accomplish this function. A mechanism may be employed to release the handle from its stowed, spring-loaded position. The handle can thereafter be turned so that the securing elements connected to the handle behind the door will rotate to a release position so that the door can be opened. After the door is closed, the handle is turned to the locking position and pushed in against the force of the spring to its stowed position, being secured there by the release mechanism. The handle may reside in a recessed housing or in a cutout of the door.

A problem exists, however, with these devices in that there is no provision made to prevent the handle from being pushed in when it is not aligned with the recess in the door. If the handle is jammed against the door it can cause damage to either the handle or the door. There is therefore a need in the art for a door latch which prevents the handle from being pushed in unless it is properly aligned with its receiving recess. There is a further need for a door latch with this capability that is also compact and can be mounted directly to the door without a surrounding housing. Latches of this type need to be lightweight and easy to disassemble or replace when maintenance is called for. These needs are particularly acute in the aircraft industry.

### SUMMARY OF THE INVENTION

The flush-type latch of the present invention comprises a substantially cylindrical body having a flange adjacent one end and clamp means adjacent the other end for releasably mounting the latch to a panel such as a door panel. A cylindrical outer sleeve is axially retained within the body and is rotatable between two positions: a latch-open position and a latch-closed position. A handle is connected to an inner sleeve that is closely fitted within and keyed to a concentric outer sleeve to prevent relative rotation between the sleeves. This construction permits the inner sleeve to slide axially within the outer sleeve between extended and retracted positions while the sleeves must turn together. At least one inwardly extending control pin is affixed to the latch body and passes through aligned slots in both of the sleeves. By the location and direction of the slots, the rotation of the sleeves is permitted only when the inner sleeve is in the extended position. Furthermore, movement of the handle and inner sleeve axially to the retracted and stowed position is only permitted when the sleeves are in the latch closed position. A locking latch arm is affixed to the end of the outer sleeve and moves with turning the handle through the interconnecting engagement of the sleeves. As is customary, the locking arm is engageable with a suitable stationary structure to which the door panel can be secured.

The inner sleeve is spring-biased in the extended position and held down in the retracted position by a catch and release trigger mechanism located in the top of the handle. This creates a convenient “pop-out” retractable handle that can reside wholly within a closely fitting outer housing or a recess formed or cut into the panel to which the latch is mounted. When installed, the latch body passes through a mounting hole in the panel and is clamped between an upper flange on the latch body and a threaded lock nut near the opposite end of the body. For further ease of maintenance, the locking arm is independently affixed to the latch mechanism by a threaded bolt so it can be removed without disturbing the rest of the latch. Thus, for ease of maintenance the entire latch assembly may be removed by loosening only one nut and one bolt.

In preferred embodiments of the invention, the door latch has a retractable handle in which the handle can only be turned when it is in the extended position and in which the handle can only be retracted to the stowed position when it has first been rotated to the latch-closed position. In other preferred embodiments, the door latch does not require a surrounding housing and thus occupies a small volume. In other preferred embodiments, the door latch has a limited number of parts that may easily be disassembled for maintenance or replacement.

### BRIEF DESCRIPTION OF THE DRAWINGS

FIG. 1 is a perspective view of a latch in accordance with a preferred embodiment of the invention shown in a retracted position;

FIG. 2 is perspective view of the latch of FIG. 1 shown in an extended position;

FIG. 3 is a side elevation of the latch shown in FIG. 1 installed on a door panel (27) and stationary structure (28) shown in cross section;

FIG. 4 is a sectional view of the latch taken along lines 4-4 of FIG. 1;

FIG. 5 is an exploded assembly view of the latch of FIG. 1;

FIG. 6 is a perspective in partial section of the inner sleeve (32), outer sleeve (36) and latch body (19) of the latch of FIG. 1; and,

FIG. 7 is a sectional view taken along lines 7-7 of FIG. 2.

### DESCRIPTION OF THE PREFERRED EMBODIMENT

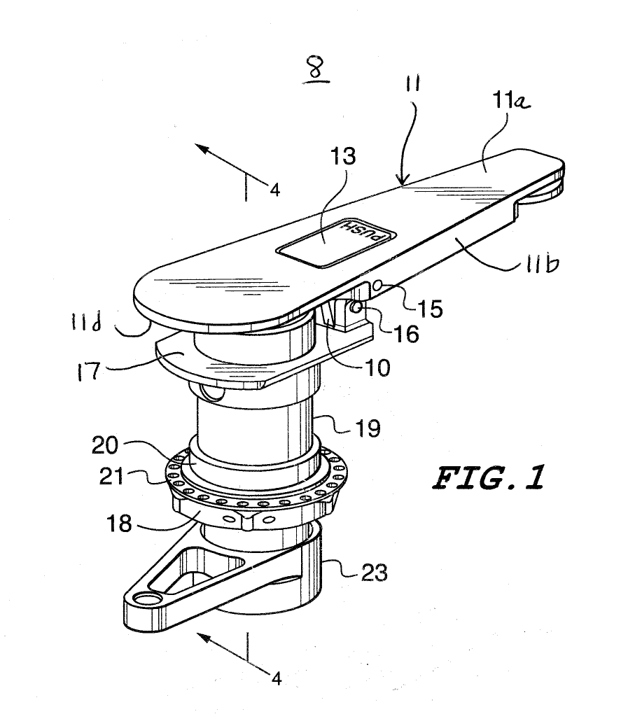

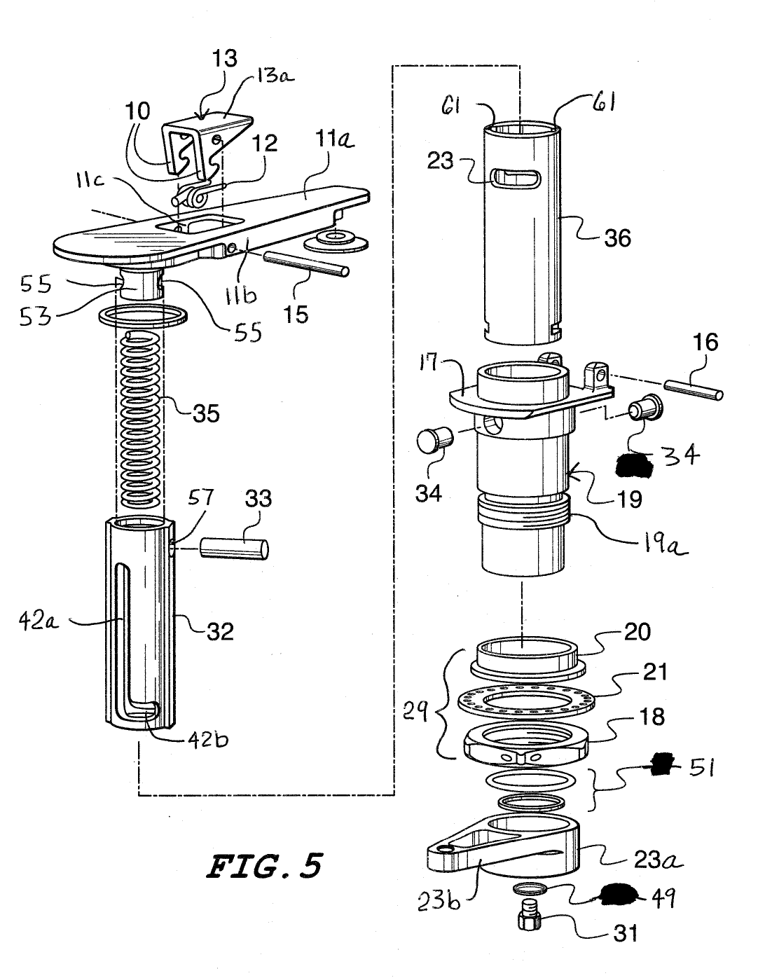

A latch in accordance with a preferred embodiment of the invention is shown in FIG. 1 and is designated generally by reference numeral 8. The latch 8 includes an elongate handle 11 having a generally-planar top surface 11a, opposed side walls 11b, a central aperture 11c, and a bottom surface 11d. As best seen in FIG. 5, a release trigger 13 is mounted in the aperture 11c. The release trigger 13 has a planar top surface 13a that aligns generally-coplanar with the top surface 11a of the handle, and two catches 10 on a barbed portion that extends generally transverse to the top surface 13a. The trigger 13 is pivotally mounted on a widthwise-extending pin 15 that is seated in the opposed side walls 11b of the handle 11. The trigger 13 pivots between first and second limit positions by depressing the top surface 13a against the biasing force of a torsion spring 12 surrounding the pivot pin 15. In the first limit position, the catches 10 engage a widthwise-extending catch pin 16 and hold the handle 11 in a retracted position (when desired) as depicted in FIG. 1. In a second limit position, the catches 10 disengage from the catch pin 16 and allow the handle to be extended by the biasing force of a compression spring 35 within the inner sleeve 32 described below. Since the catches 10 are barbed, they are self-actuating by spring-biased lever action against the catch pin 16 as the handle is pushed into the fully retracted position.

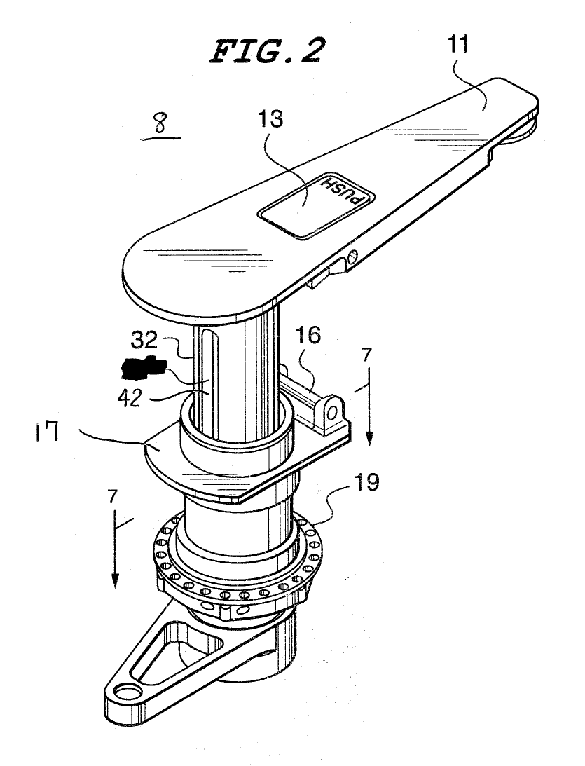

Referring to FIG. 5, a cylindrical hub 53 is fixed to and extends generally transverse from the bottom side 11d of the handle 11. With reference to the handle shown in FIGS. 1 and 2, the hub 53 is fixed proximate the wider end of the handle, whereas the narrower end of the handle 11 is the portion to which the user grasps by hand. As best seen in FIG. 5, the hub has a pair of diametrically-opposed apertures 55 in the side walls. The apertures 55 are constructed and arranged in size and shape to align with a pair of apertures 57 in the inner sleeve 32 described below.

The hub 53 is designed to coaxially align with and connect to an inner sleeve 32. The inner sleeve has an elongate, generally-cylindrical shape. The inner diameter of the inner sleeve 32 is slightly larger than the outer diameter of the hub so that the hub 53 can coaxially align with and be inserted into the proximal (relative to the handle) end of the inner sleeve 32. To connect the hub 53 to the inner sleeve, a pin 33 is inserted into the aligned apertures 55 and 57.

The outer surface of the inner sleeve 32 has diametrically-opposed, axially-extending splines 59. In preferred embodiments, the splines 59 extend along the entire length of the inner sleeve 32. As described below, the splines 59 are constructed and arranged to cooperatively engage and freely reciprocate within similarly-shaped grooves 61 in an outer sleeve 36. The inner sleeve also has a pair of diametrically-opposed, L-shaped, motion-control slots 42 in the annular wall intermediate the splines 59. In a preferred embodiment shown in FIG. 5, the motion-control slots 42 have a first portion 42a that extends axially along a substantial portion of the length of the inner sleeve (axial portion), and a second portion 42b that extends circumferentially less than about half of the circumference of the cylindrical wall of the inner sleeve (circumferential portion). As described below, the slots 42 control axial and rotational movement of the handle cooperatively with several other components.

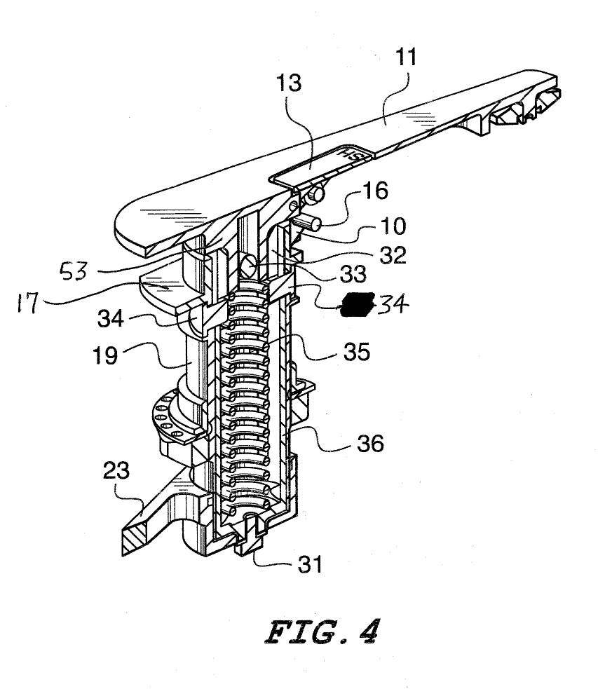

A pop-out biasing means is housed within the inner sleeve 32. In preferred embodiments, the pop-out biasing means comprises a compression spring 32. One end of the spring 32 contacts the distal end (relative to the handle) of the hub 53 while the other end sits on the bottom of the outer sleeve 36 as best seen in FIG. 4. As described below, the compression spring 32 urges the handle from the retracted position to the extended position when the handle 11 is rotated to a particular angular orientation relative to the latch body 19.

The inner sleeve cooperatively engages and telescopes within an outer sleeve 36. The outer sleeve 36 is generally cylindrical and has an inner diameter slightly larger than the outer diameter of the inner sleeve 32. A pair of axially-extending grooves 61 is formed in the interior surface of the outer sleeve 36. In a preferred embodiment, the grooves extend the entire length of the outer sleeve 36 and have a shape that compliments the shape of the splines 44 so that the inner sleeve 32 can only translate axially within the outer sleeve 36.

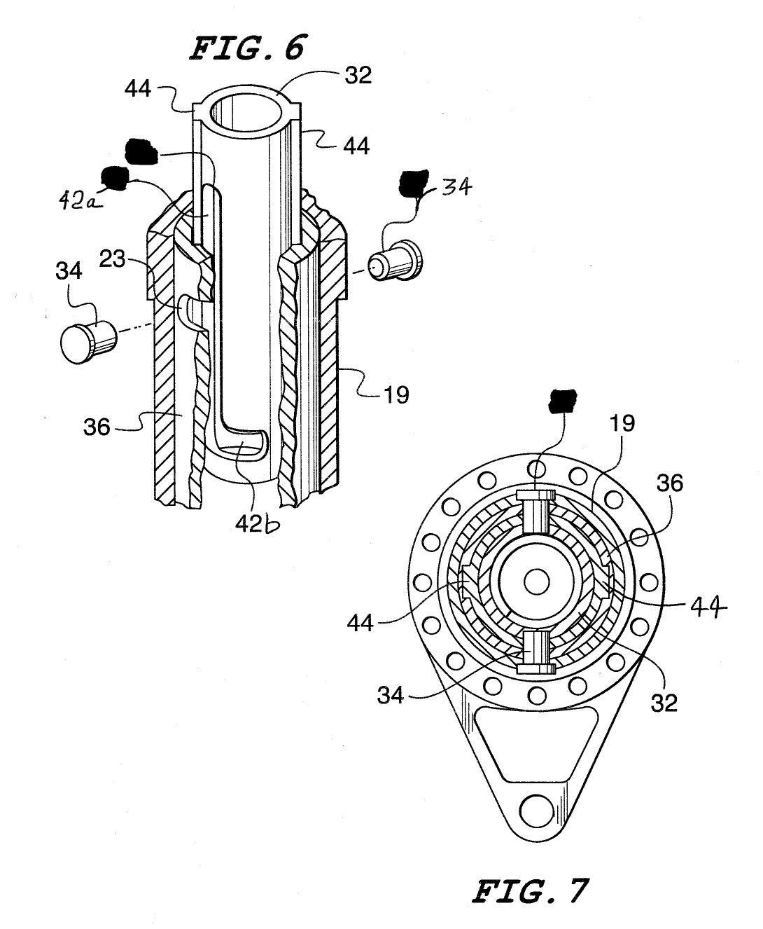

The outer sleeve 36 has a pair of circumferentially-extending, motion-control slots 23 in the annular side wall. Preferably, the motion-control slots 23 are located near the proximal (relative to the handle) end of the outer sleeve 36. The slots 23 are constructed and arranged to engage a pair of diametrically-opposed control pins 34 extending through the valve body 19. The control pins 34 restrict translational (axial) movement of the outer sleeve in the valve body 19 and restrict rotational movement to a distance equal to the angular length of the slots 23. As best seen in FIGS. 6 and 7, the control pins 34 also extend through the slots 42 in the inner sleeve 32. As described in greater detail, the control pins 34 restrict movement of the inner sleeve within the valve body to translational (axial) movement only at one angular orientation, and to rotational movement only at its most resected axial position.

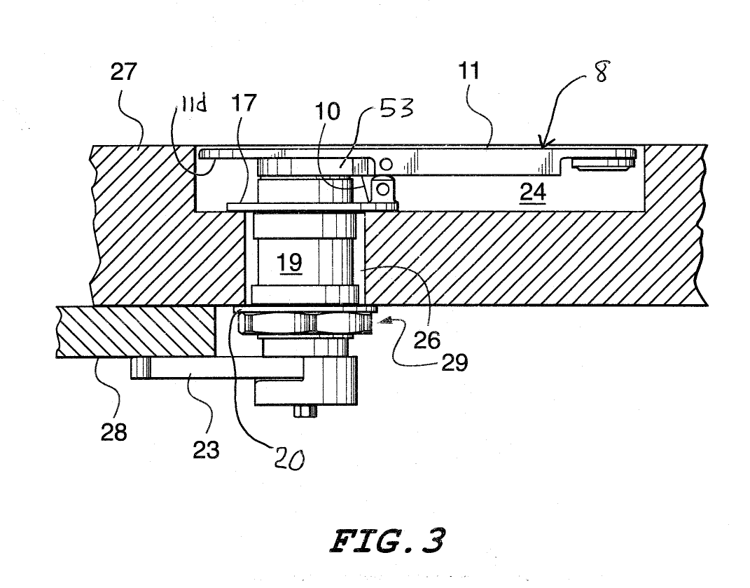

As best seen in FIG. 5, the latch 8 has a body 19 that is substantially cylindrical and has an integral flange 17 proximate the top and a threaded portion 19a proximate the bottom. The threaded portion 19a of the body engages a clamp nut assembly 29 that includes a collar 20, pressure lock ring 21 and lock nut 18, which provides a mounting (clamp) force to a door panel captured between the flange 17 and the collar 20 as best seen in FIG. 3.

A lock arm 23 projects radially outwardly from the bottom of the latch body 19. The lock arm 23 has a generally-cylindrical body 23a and an integrally-formed, radially-projecting arm 23b as best seen in FIGS. 1, 2 and 5. The body 23a aligns axially with the latch body 19 and overlaps with it slightly. The arm body 23a is rotatably fixed to the latch body by a lock nut 31 and washer 49. A plurality of washers 51 sit in between the arm body 23 and the axial end of the latch body 19 and allow the lock arm 23 to rotate into engagement with a stationary securing structure 28 such as shown in FIG. 3.

In FIG. 2, the latch 8 is depicted in the released or extended position relative to the door panel to which the latch 8 is connected. When the trigger 13 is depressed, the catches 10 release from the catch pin 16 and the compression spring 35 urges the handle 11 outwardly. This feature is necessary when the latch is installed flush or sub-flush as shown in FIG. 3.

In FIG. 3, the latch 8 is shown installed on a door panel 27 through a receiving hole 26 in the panel 27. The latch 8 is mounted to the panel by a clamp force applied by the clamp nut assembly 29. The body flange 17 tightens against the outer surface of the panel 27 while the collar 20 tightens against the inner surface of the panel 27. When locked down, the latch handle 11 resides with a cavity 24 in the outer surface of the door panel 27 so that the handle 11 is flush or sub-flush with the outer surface. As further described herein, the handle 11 can be extended out of the recess 24 by depressing the trigger 13 and releasing the catches 10. Then, when the handle is rotated, the locking arm 23 also rotates and disengages from the backside of the stationary structure 28. The door panel 27 may then be opened.

The internal construction of the latch 8 is shown in greater detail in FIG. 4 in the retracted position. The catches 10 of the trigger 13 engage the catch pin 16 and releasably hold the handle in the retracted position against the force of the compressed pop-out spring 35. The compression spring 35 extends through the inner sleeve 32, which is open at both ends. The bottom or distal (relative to the handle) end of the spring 35 abuts the bottom end wall of the concentric outer sleeve 36. The top or proximal (relative to the handle) end of the spring abuts the cylindrical hub 53 of the handle 11. The handle 11 is rigidly affixed to the inner sleeve 32 by a pin 33 that is inserted through aligned bores 55, 57. The inner sleeve 32 slidably engages the outer sleeve 36 by means of the splines 44 and mating grooves 61, which prevent the inner sleeve 32 from rotating relative to the outer sleeve 36 as seen more clearly in FIGS. 6 and 7. Both sleeves are held captive to the latch body 19 by motion control pins 34, which also prevent the sleeves from being pulled apart. This construction permits the inner sleeve 32 and handle 11 to telescope toward and away from the latch body 19 while the outer sleeve is permitted to rotate within the latch body 19. The lock arm 23 is connected to the end of the outer sleeve 36 by the bolt 31. Mating features (not shown) on the lock arm and outer sleeve end wall prevent their relative rotation.

FIG. 5 shows an exploded assembly view of the latch 8. This Figure more clearly shows the trigger spring 12, which is held in operational position within the handle 11 by the pin 15, and the barbed shape of the catches 10. The alignment of the control pins 34 through holes in the latch body 19, through the motion-control slots 23 of the outer sleeve 36, and through the motion-control slots 42 of the inner sleeve captivate the handle 11 to the latch body 19 while limiting its rotation, and hence the rotational position of the lock arm 23. The elements of the clamp nut assembly 29 and lock arm assembly are shown with like numbering as used in FIGS. 1-4. These elements include the collar 20, pressure lock ring 21, lock nut 18, pressure seals 51, lock arm 23, bolt 31 and washer 49.

The inner and outer sleeves are shown in more detail in FIGS. 6 and 7. Both sleeves are diametrically symmetrical so that the structural features are identical pairs located 180 degrees apart. As seen in FIG. 6, the inner sleeve 32 has two motion control features; the pair of diametrically-opposed L-shaped slots 42 (only one shown here), and the two splines 44. The splines 44 engage the grooves 61 in the outer sleeve 36. The mating splines 44 and grooves 61 permit the sleeves to telescope but lock them against relative rotation. The axial portion 42a of the slots 42 prevent rotational movement of the inner sleeve 32 and handle 11 until the point of full extension of the inner sleeve 32. This occurs when the control pins 34 are located at the bottom end of axial portion 42a of the slots 42. At that location, the control pins 34 are also located in the circumferential portion 42b of the slots 42. Only then can the handle 11 be turned from the latch-closed position to the latch-open position. With the handle 11 turned to the latch-open position, the control pins 34 contact the ends of circumferential portion 42b and are no longer in alignment with the axial portion 42a so that the handle 11 cannot be pushed inward to the retracted position. As best seen in FIGS. 5 and 7, the control pins 34 are fixed in radial bores in the housing 19 and extend inwardly through the outer sleeve 36 and then farther inwardly through the inner sleeve 32 as described above.

By the mechanical relations depicted in FIGS. 1-7 and as described above, it will be understood that the handle is rigidly connected to the lock arm rotationally while in slideable engagement with the latch body through engagement of the interconnecting sleeves. The sleeve slots and control pins allow the handle to be turned and moved toward or away from the body of the latch but in a controlled way. The handle can only be pushed to the retracted position when the rotation of the handle is returned to the latch-closed position and the handle is in alignment with the recess in the panel.

Opening the latch from the closed retracted position is a three-step operation. The latch is shown in the latch-closed position and fully retracted. When the trigger 13 is depressed, the catches 10 are released, which allows the handle 11 to be pushed outwardly and extended by the force of the compression spring 35. In this position shown in FIG. 2, the handle 11 can be easily grasped and rotated. This feature is essential if the latch handle is to be retracted and locked in a recess within the panel 27 as shown in FIG. 3. Once extended, the handle 11 and lock arm 23 can be rotated to the latch-open position. Rotation is permitted only in this extended position because of the control means discussed above. Afterward, the handle can be rotated back to the latch-closed position by reversing the steps of this sequence and pushing the handle to the fully retracted position against the force of the compression spring 35. The above-described motion control means will not allow the handle to be pushed inwardly to the closed position unless the handle is first rotated to the closed position wherein the handle 11 is properly aligned with the recess in the door panel 27. This functionality is an important aspect of the invention and prevents damage to the panel if the handle is pushed into contact with the panel (retracted) when it is not in alignment with the panel recess. When fully retracted, the handle is then secured in the closed position by the self-actuating reengagement of the trigger catches 10.

From the above description it will be apparent that the invention includes a compact latch occupying a very limited volume with minimal weight because the construction of the latch permits it to be mounted directly into a panel aperture. The latch is easy to repair or replace because the entire unit can be released from the moveable structure to which it is attached, such as a swing door, by unscrewing at most only two elements, a bolt and a nut. The lock arm is the component of the latch assembly which experiences the most wear and thus may need replacement over time. This can be done by removing only one retaining bolt without the need for disturbing the rest of the latch. The latch 8 also incorporates handle motion control means that prevents damage to the retractable handle and door panel.

It will be readily understood by those in the mechanical arts that the dimensions of the various components of the invention can be selected to operate as described above without limitation to the particular configuration, proportions and dimensions shown in the preferred embodiment. As such the invention is to be defined only by the following claims and their legal equivalents.

1. A panel latch, comprising:
a latch body having a flange adjacent one end and clamp means adjacent the other end for releasably mounting the body to a panel between the flange and the clamp means;
an outer sleeve axially retained within said body and rotatable within a limited range between a latch-open position and a latch-closed position;
an inner sleeve closely fitted within said outer sleeve having anti-rotation features preventing relative rotation with the outer sleeve while being axially reciprocal within said outer sleeve between extended and retracted positions of the inner sleeve;
at least one control pin affixed to said body and passing through aligned slots in both the outer sleeve and the inner sleeve such that the rotational motion of said outer sleeve and said inner sleeve with respect to the body is permitted only when the inner sleeve is in the extended position;
a handle affixed to a top end of the inner sleeve; and
a locking arm affixed to a bottom end of the outer sleeve.

2. The device of claim 1 wherein movement of the inner sleeve from the extended position to the retracted position is limited to the point when the outer sleeve is in the latch-closed position.

3. The device of claim 2 wherein the outer sleeve slot has a circumferential slot through a wall of the outer sleeve.

4. The device of claim 3 further including a second circumferential slot through the wall of the outer sleeve equal in length and located diametrically opposite the first circumferential slot.

5. The device of claim 2 wherein the inner sleeve slot includes an L-shaped slot through a wall of the inner sleeve comprising an axial portion and a circumferential portion.

6. The device of claim 5 further including a second L-shaped slot through the wall of the inner sleeve identical to the first L-shaped slot located diametrically opposite the first L-shaped slot.

7. The device of claim 1 further including a second control pin affixed to the latch body located diametrically opposite the first control pin and passing through aligned slots in the outer and inner sleeves.

8. The device of claim 5 wherein the control pin occupies the circumferential portion of the inner sleeve L-shaped slot only when the inner sleeve is in the extended position.

9. The device of claim 5 wherein the range of motion of the inner sleeve between the retracted and extended positions is defined by the axial leg of the L-shaped slot.

10. The device of claim 1 wherein the anti-rotation feature is at least one spline projecting outwardly from the inner sleeve.

11. The device of claim 10 wherein the outer sleeve includes a groove that closely receives the spline on the inner sleeve.

12. The device of claim 1 further including a spring operative between a bottom of the outer sleeve and the handle for forcefully biasing the handle toward the extended position of the inner sleeve.

13. The device of claim 1 wherein the lock arm is releasably affixed to a bottom of the outer sleeve.

14. The device of claim 1 wherein the latch body is substantially cylindrical.

15. The device of claim 14 further including nut means threadably engaging the latch body for applying a clamp force to the panel located between the nut and the flange.

16. The device of claim 15 further including a panel clamped between the nut and the flange.

17. The device of claim 16 wherein the panel includes a recess which receives the handle when the inner sleeve is in the retracted position such that the handle lies flush with portions of the panel surrounding the recess.

18. The device of claim 12 further including a trigger affixed to the handle which releasably holds the handle to the latch body in the retracted position of the inner sleeve against the force of the spring.

19. The device of claim 18 wherein the trigger includes a self-actuating spring-biased catch portion that hooks onto a pin affixed to the latch body to hold the handle in the retracted position.
